(19) United States
(12) Patent Application Publication
(10) Pub. No.: US 2013/0077306 A1
(43) Pub. Date: Mar. 28, 2013

(54) LED LIGHTING LAMP

(71) Applicant: Kszysztof Wlodzimierz Lagutko, Warszawa (PL)

(72) Inventor: Kszysztof Wlodzimierz Lagutko, Warszawa (PL)

(21) Appl. No.: 13/581,092

(22) PCT Filed: Feb. 24, 2011
(86) PCT No.: PCT/PL11/00022

§ 371 Date: Dec. 6, 2012

(30) Foreign Application Priority Data
Feb. 25, 2010 (PL) P.390552

(51) Int. Cl. F21V 5/04

(52) U.S. Cl. CPC F21V 5/04
USPC 362/244

(57) ABSTRACT

An LED lighting lamp contains a cover, having a port for power leads, ports for cover fixing, an external collar, catches, feeding socket and feeders' connecting cube, fixed inside the cover to its bottom; a housing, having an external collar with rectangular recess, protrusions arranged on the vertical walls inside the housing, bars, catches, a seat in which the PIN ends are fastened to be connected with feeding socket, wherein the catches are connected with cover catches; an electronic board of the feeder, with ports for housing bars, electronic elements and electrical connectors placed on the upper surface as well as connector support placed on the lower surface; insulation molder, fastened in the housing collar's recess and having a central rectangular cavity with rectangular and round ports in its bottom; a radiator in the form of a rectangular molder, fastened in the cavity of insulation molder and having on its upper surface a central rectangular seat, inside which, at least two bars and one port are placed on its lower surface.

### FIELD OF THE INVENTION

The present invention relates to the LED lighting lamp being a light source suitable for illuminating rooms, staircases, corridors, passageways, cellars—all the places, where temporary space lighting is needed.

### BACKGROUND OF THE INVENTION

The solutions of staircases', passageways' and cellars' lighting based on traditional incandescent bulbs, fluorescent lamps or energy-saving bulbs, switched on by conventional circuit-breakers and equipped with time-lag switches, turning the lights off after a pre-set time, regardless of whether the user or users need such lighting or not—are commonly known. Another drawback of such solutions is the need to install multiple switches and connect them by electric wiring with power line supplying light sources.

The solutions of staircases', corridors', passageways' and cellars' lighting based on traditional lamp with an external motion sensor and time-lag switch, turning the lights off after a pre-set time, regardless of whether the user or users need such lighting or not are also commonly known. The advantages of these solutions consist in eliminating the need of searching for circuit-breaker in a dark room as well as lower power consumption compared to no motion sensor lighting (for example—nine times lower). The inconvenience of these solutions is, that due to the high working temperature of traditional light-bulbs requires the motion sensor to be installed not closer than 0.5 metres from them, which causes high costs of equipment, due to high installation costs. Another important drawback consists in frequent need to exchange light-bulbs, especially energy-saving ones, due to their short life in continuous switching on and off cycles. Another inconvenience leading to installation costs increase is the need to mount motion sensors at all entrances or on each floor.

In turn, possibilities to apply LED lamps were so far limited, due to their too weak power. When high power LEDs appeared, carrying away of heat—especially in case of diodes working in lighting sets—has become a problem.

The object of present invention is to provide the LED lamp construction suitable for illuminating rooms, staircases, corridors, passageways and cellars, which could enable an efficient carrying away of heat emitted by operating LEDs, especially HB LED type, and consequently, give possibility to assemble in one housing lighting elements of any power and, at least, a motion sensor and/or other sensors.

Furthermore, the present invention is aimed at achieving lighting LED lamp construction, allowing its easy and simple installation and servicing, without using specialized equipment.

The present invention is also aimed at working out a lighting LED lamp structure, allowing to exploit the existing lighting installations—supplying points, without doing additional mounting works.

### SUMMARY OF THE INVENTION

The object of invention have been achieved by designing a LED lamp, which—according to its concept—contains: a cover in the form of cubicoid open at the top, with

“U” letter shaped cross-section, having a port for power leads, ports for cover fixing, an external collar, catches, feeding socket and feeders' connecting cube, fixed inside the cover to its bottom; a housing in the form of cubicoid open at the top, with

“U” letter shaped cross-section, having an external collar with rectangular recess, protrusions arranged on the vertical walls inside the housing, bars, catches, a seat in which the PIN ends are fastened to be connected with feeding socket, wherein the catches are connected with cover catches; an electronic board of the feeder, with ports for housing bars, electronic elements and electrical connectors placed on the upper surface as well as connector support placed on the lower surface and connected with PIN end's pins of the housing's seat; insulation moulder in the form of a rectangular plate, fastened in the housing collar's recess and having a central rectangular cavity with “U” letter shaped cross-section and rectangular and round ports in its bottom; a radiator in the form of a rectangular moulder, fastened in the cavity of insulation moulder and having on its upper surface a central rectangular seat with “U” letter shape cross-section, inside which, at least two bars and one port are placed on its lower surface; two rectangular seats with “U” letter shaped cross-section, placed in parallel on both sides of the central seat, having a depth lower than the central seat as well as the equal width, each of them having in its bottom a port and at least two bars situated on the lower surface of the radiator, which pass through the holes in insulation moulder, pressing the electronic board of the feeder against protrusions in housing, and—at least—two ports for screws, insulation moulder fixed in the central seat of radiator and having in its bottom at least two ports for bars, one rectangular port with a collar situated on the external surface of insulation moulder's bottom, passing outside radiator through the rectangular hole in the bottom of radiator's central cavity; PIR sensor electronic board, fastened in the insulation moulder, keeping a gap from its bottom and supported by the radiator's bars; at least two plates with LEDs, fastened in radiator's shallow seats in such a way that the lower surface of the plate keeps direct contact with the bottom surface of radiator's seat; a rectangular frontal plate, connected by screws to the bars and fixing the radiator in insulation moulder's cavity, having a central rectangular hole, notches in the corners, ports for screws and an insulating moulder in housing collar's recess, top cover in the form of rectangular moulder, having at least two longitudinal, rectangular ports with seats from underneath, a central large-diameter port, two small-diameter ports situated on opposite sides of the central port and having seats from the top cover's bottom side, at least two protrusions with springy catches, situated along opposite sides of the top cover, fastened in the frontal plate's notches and connecting the top cover with

the frontal plate; light source lenses, fixed with LED plates in radiator's seats by use of seats in the top cover, pressing LED plates against seats' bottoms; optical element of PIR sensor, fitted in the central port, between PIR sensor electronic board and the top cover, and adjustment knobs, fixed in top cover's seats, between PIR sensor electronic board and the top cover.

Preferably, the cover has a collar in the form of cylinder, in which a feeding socket as well as a seat to fix the connecting cube are fastened.

Preferably, the feeding socket is fixed to the cover's bottom with screws and nuts.

Preferably, the housing has on its lower surface a collar in the form of cylinder, concentric with the seat for an additional feeding socket's insulation. Preferably, the bars have ends with smaller diameters than their other sections, allowing them to enter into the holes in the electronic board of the feeder.

Preferably, the bars have ends with smaller diameters than their other sections, allowing them to enter into the holes in PIR sensor electronic board.

Preferably, on the upper surface of the PIR sensor electronic board a base and electronic elements of PIR sensor are fixed, while electrical outputs in the form of pins, passing through insulation moulder's collar and introduced to the connector in the electronic board of the feeder are placed on the lower surface of the PIR sensor electronic board.

Preferably, the electronic LEDs plate has electronic elements and at least one LED fixed on its upper surface, while electrical outputs in the form of pins, passing through the hole in radiator's seat and introduced to the connector in the electronic board of the feeder are placed on the lower surface.

Preferably, a cuboidal moulder of trapezoidal cross-section, having an internal longitudinal channel with a convex, half-round bottom makes the light source lens.

Preferably, the light source lens is constituted by an eliptical lens compound.

Preferably, a dome is the optical element of PIR sensor.

Preferably, a Fresnel lens is the optical element of PIR sensor.

Preferably, springy catches make the integral part of top cover's protrusions. Thanks to the applied lamp construction according to the invention it was possible to integrate the lamp with a motion sensor in one compact housing, which allowed to eliminate logistic problem as well as the mounting costs—the mounting is the same as in case of usual ceiling fittings and it is possible to use the existing outputs of lighting installation.

The application of low thermal resistance materials for installation of LEDs extends the life of lamps.

The application of double voltage insulation ensures compliance with safety standards and CE requirements.

The application of special designs enables fully automatic installation, eliminating manual works.

### BRIEF DESCRIPTION OF THE DRAWINGS

The subject of invention is shown in the drawing, where

FIG. 1 shows an advisable execution of LED lighting lamp, made according to the invention is presented in exploding, perspective side-view,

FIG. 2 shows the LED lighting lamp in front-view,

FIG. 3 shows the LED lighting lamp in A-A (as marked in FIG. 2) cross-section,

FIG. 4 shows the LED lighting lamp in B-B (as marked in FIG. 2) cross-section is shown in FIG. 4.

### DETAILED DESCRIPTION OF THE INVENTION

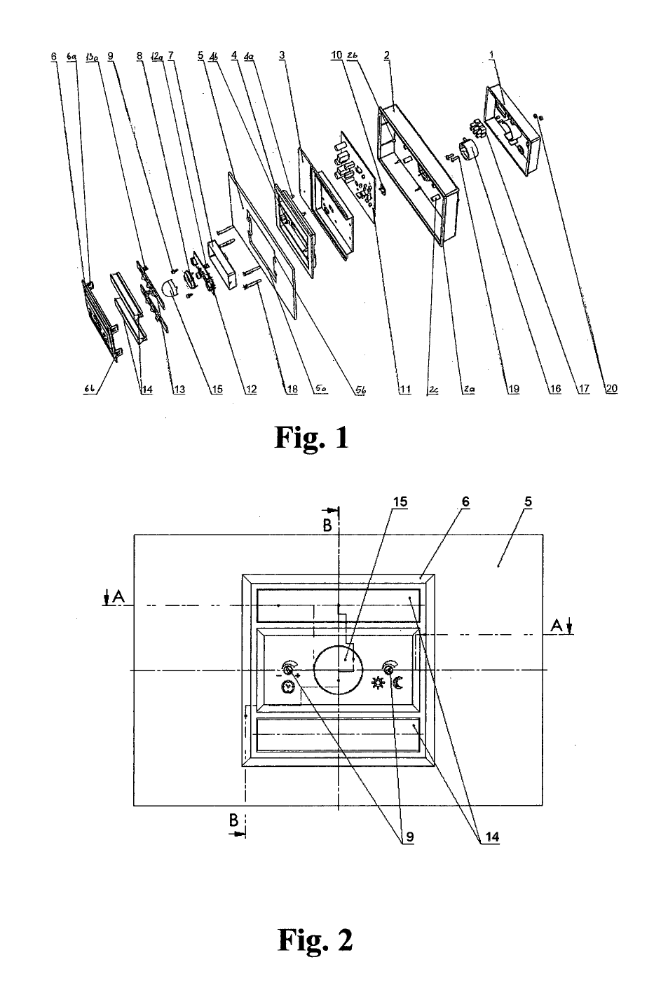

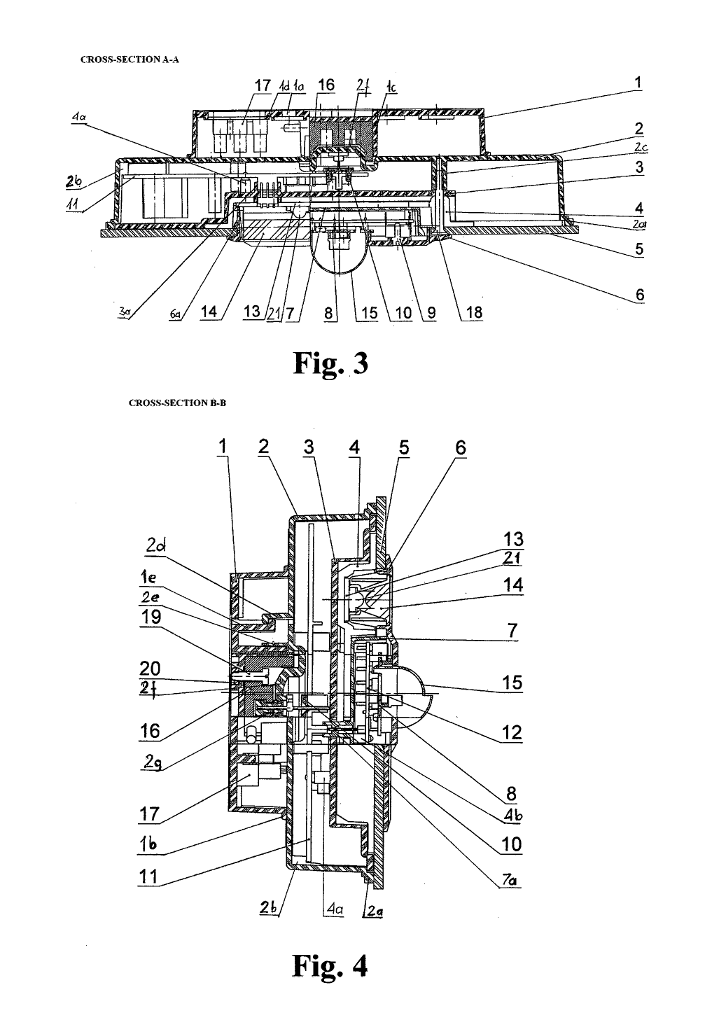

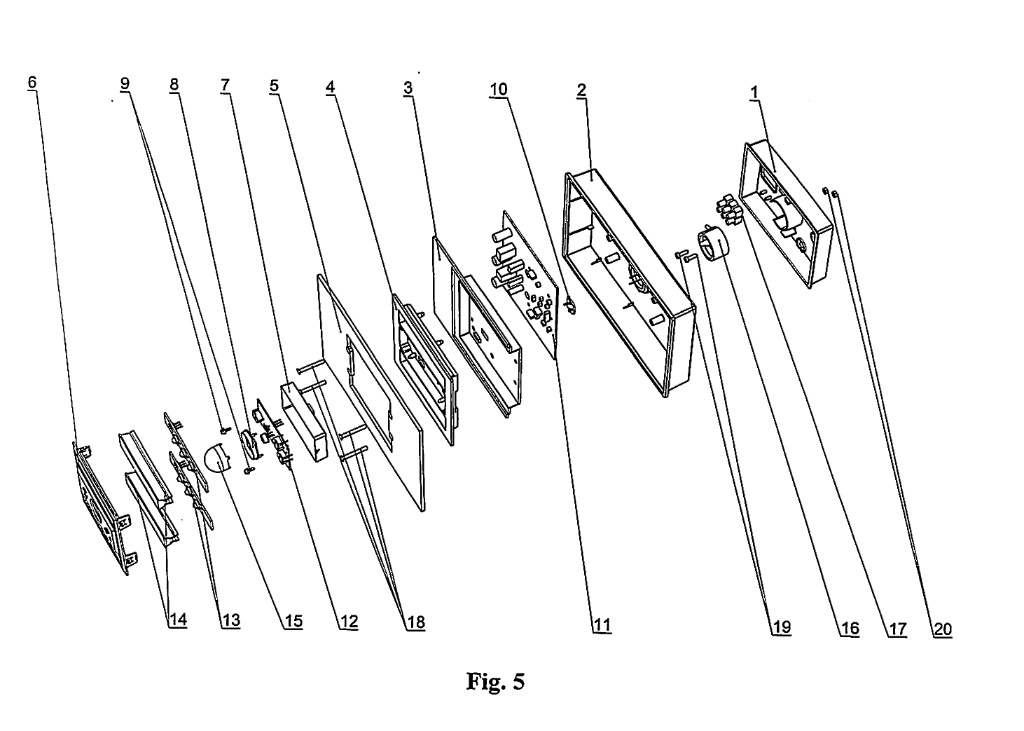

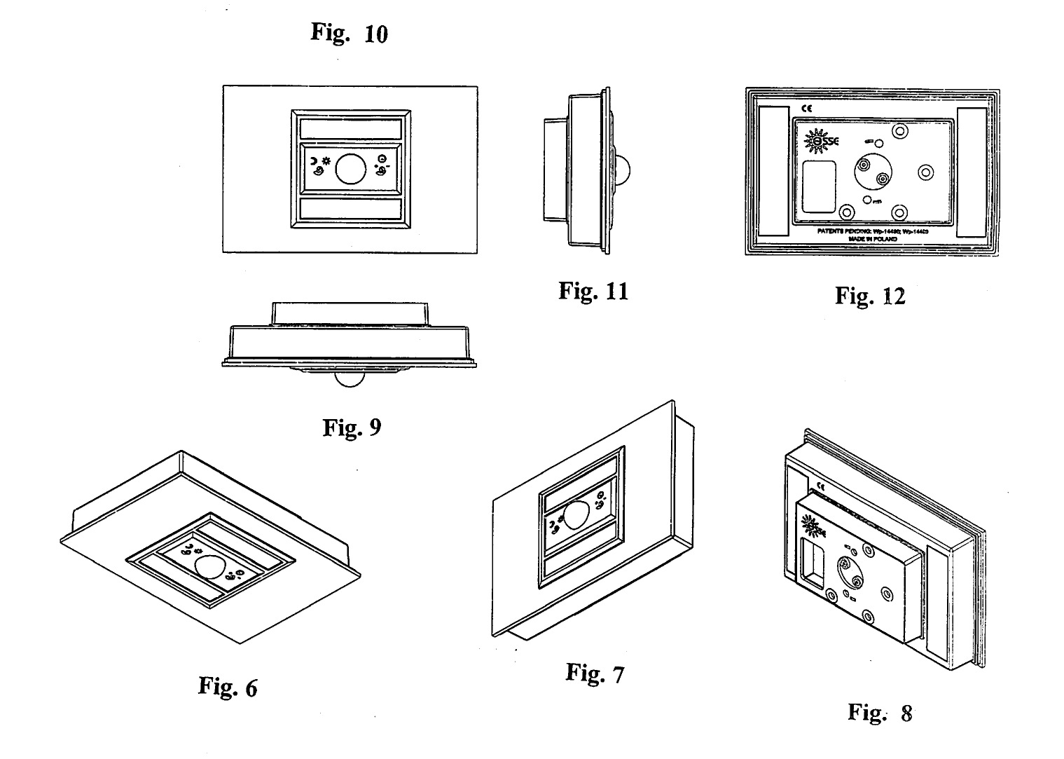

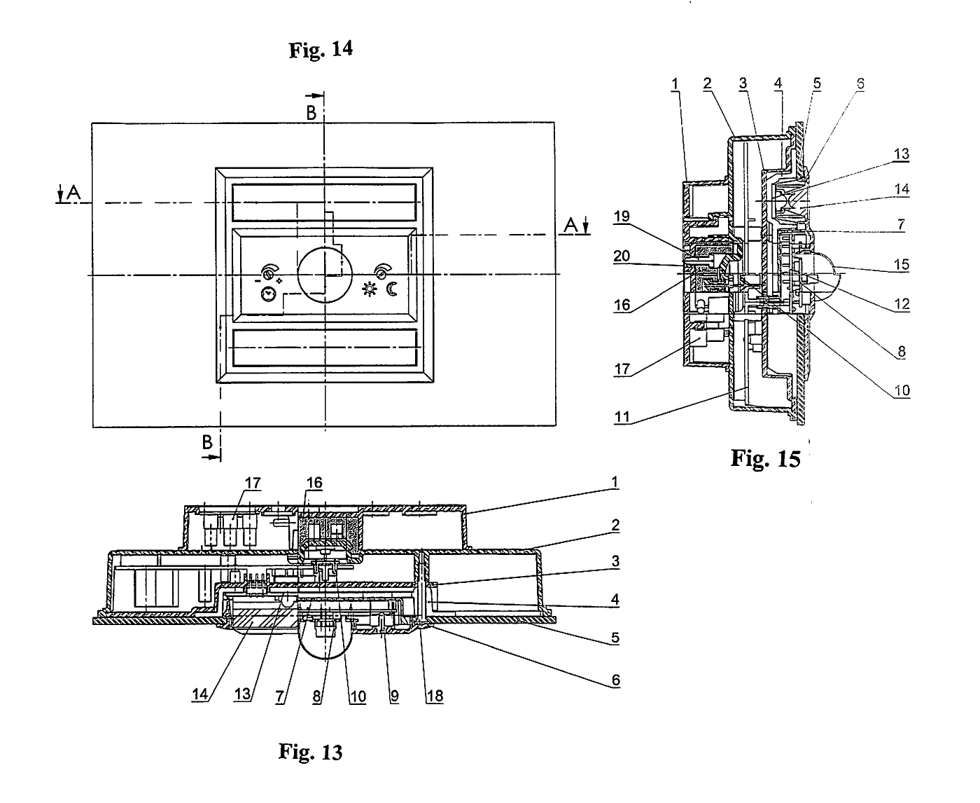

The LED lighting lamp made according to the invention has been described as in advisable execution example presented in FIG. 1, FIG. 2 and FIG. 3. The LED lighting lamp made according to the invention is composed of feeding socket's 17 cover 1, feeder's housing 2, electronic board of feeder 11, feeder's insulation moulder 3, radiator 4, insulation moulder 7, plates 13 with LEDs 21, PIR sensor electronic board 12, protective dome 15 of PIR sensor, lenses 14, frontal plate 5 and top cover 6. The frontal plate is connected with housing 2 by use of screws 18.

The cover 1 of feeding socket has a form of a cubicoid open at the top, with “U” letter shaped cross-section, having a port 1a for power leads, the external collar 1b on the circumference of the upper, open part as well as the seat 1c to fit the feeding socket 16, and the seat 1d to fix the feeders' connecting cube 17, which are placed on the internal, bottom surface of the cover.

The cover 1 is equipped with catches 1e to be connected with catches 2d of the housing 2. The catches 1e and 2d have, for example, the form of hooks. The feeding socket 16, for example, a socket of GU 10type, is fastened firmly in the seat 1c of the housing 1—for example with screws 19 and nuts 20. The feeders' connecting cube 17 is fastened to the bottom of the cover 1. The holes in the cover 1 serve to fasten it on the wall, ceiling or other surface. The cover 1 is fastened at the points, in which lighting point is foreseen.

It is obvious, that the cover 1 does not need to be equipped with the seat 1c for fitting the feeding socket 16 as well as the seat 1d for feeders' connecting cube 17 fixing—both the feeding socket 16 and feeders' connecting cube 17 can be mounted directly on the surface of cover's 1 bottom.

It is also obvious, that any optional way to fasten the socket 16 and connecting cube 17, for example by riveting, gluing etc., is admissible.

The cover 1 is made of any electroinsulating plastic, preferably of ABS (Acrylonitrile Butadiene Styrene).

The feeder's housing 2 has a form of a cubicoid open at the top, with “U” letter shape cross-section, having the external collar 2a with rectangular recess around the whole circumference of the upper open part, the protrusions 2b for fixing the feeder's electronic board 11 inside the housing, arranged on vertical walls of the housing 2 as well as the bars 2c for fastening the frontal plate 5, by—for example—screws 18. The housing 2 has catches 2d at its bottom, the collar 2e in the form of a cylinder and the seat 2f. The collar 2e is designed for an additional feeding socket's 16 insulation and it facilitate the insertion of the seat 2f and 2g ends into the hole in the socket 16 during assembly of the lamp.

In the seat 2f two standard PIN ends 2g are mounted. They have pins designed to connect through the base of terminal 10 with feeder's electronic board 11 and to provide feeding voltage from feeding socket 16.

The housing 2 is made of any electroinsulating plastic, for example—of ABS.

The feeder's electronic board 11 is made of standard laminate, to which electronic elements and joints are fastened, to make connections—for example, by use of pins—with the socket 16, the PIR sensor electronic board 12 and the plates with LEDs 21. The base of network feeder's terminal 10 is fastened on the lower surface of the electronic board 11. The electronic board 11 has ports designed for bars 2c for screws 18 fixing the frontal plate 5.

The insulation moulder 3 has the form of a rectangular plate with central rectangular cavity with “U” letter shaped cross-section. In this cavity the radiator 4 is fixed. The insulation moulder 3 has rectangular ports for pins 12a of PIR sensor electronic board 12 and for pins 13a of plates 13 with LEDs 21 as well as round ports for bars 4a of the radiator 4. In order to ensure an additional insulation of pins 12a, 13a against their contact with radiator 4, i.e. in order to prevent a short-circuit, guide collars along edges of rectangular holes on both surfaces of the insulation moulder 3 may be made. The insulation moulder 3 is fixed in recess of the collar 2b of the housing 2 and immobilized by the frontal plate 5.

The insulation moulder 3 is made of any electroinsulating plastic, for example—of ABS.

The radiator 4 has the form of a rectangular, monolithic moulder with central, rectangular seat. Inside the seat, on its lower surface four bars 4b and two rectangular seats having equal width are placed in parallel on both sides of the central seat. Their depth is smaller than the depth of the central seat. Inside the central seat of radiator 4 the insulation moulder 7, containing PIR sensor electronic board 12 and in radiator's 4 side seats the plates 13 with LEDs 21 are fixed.

On the lower surface of radiator 4 four bars 4a are placed. They pass through holes in the insulation moulder 3 of the feeder and press the electronic board of the feeder 11 against the protrusions 2b and housing 2.

The ends of bars 4a may preferably have a smaller diameter than remaining sections of bar 4a, so that—when the bars 4a have passed through the holes in the insulation moulder 3—they could enter into respective holes in the electronic board of the feeder 11 and press the electronic board of the feeder 11 against protrusions 2b of the feeder's housing 2, preventing displacement of feeder's electronic board 11 inside the housing 2.

After having passed through the respective holes in insulation moulder 7, bars 4b raise PIR sensor electronic board 12 above the surface of insulation moulder's 7 bottom in order to reach a gap between the surface of PIR sensor electronic board 12 and the surface of insulation moulder's 7 bottom.

The ends of bars 4b may preferably have a smaller diameter than remaining sections of bar 4b, so that they could enter into the respective holes in the PIR sensor electronic board 12 and prevent displacement of PIR sensor electronic board 12 inside insulation moulder 7.

The bars 4a and 4b may be preferably made as integral parts of radiator 4—for example, during the casting of radiator 4. They may be also manufactured as separate parts—for example as threaded ends bars, screwed or thrust into radiator 4 etc.

The radiator 4 has four ports for screws 18, made advisably along shorter sides of the central seat.

The radiator 4 is made of low thermal resistance material, for example—of aluminium or aluminium alloys.

The insulation moulder 7 has four round holes for passing bars 4b through them and one rectangular hole for pins 12a of PIR sensor electronic board 12. On its lower surface there is also an advisable cuboidal collar 7a, placed around this hole and isolating pins 12a from radiator 4.

The insulating moulder 7 is made of insulating material, preferably of plastic, for example—of ABS.

The PIR sensor electronic board 12 is made of standard laminate. On the upper surface of the board electronic elements and PIR sensor base 8 made of insulating material are fastened. The electronic plate 12 has electrical terminals, for example—in the form of pins 12a. The pins 12a pass through the hole in insulation moulder 7, advisable through the collar 7a of the insulation moulder 7, placed in the hole of radiator 4, and are introduced into the respective joint on feeder's electronic board 11.

The electronic plate 13 with LEDs 21 is a plate made of standard laminate, preferably of Alu PCB or MSPCB. On its upper surface electronic elements and at least one LED 21 are fixed, and the plate has electrical terminals, for example—in the form of pins 13a. The pins 13a pass through the holes in radiator's 4 seats and are introduced into the respective joints on feeder's electronic board 11. The lower surface of electronic plate 13 keeps direct contact with the surface of radiator's 4 seat, in order to improve the transfer of heat from LEDs 21 to radiator 4.

The frontal plate 5 of the lamp has the form of rectangular plate with central, rectangular hole 5a with notches 5b in the corners, made in such way, that two opposite rectangular protrusions with ports for screws 18 are placed on the hole axis. The screws 18 are screwed into the housing 2 bars 2c, combining into a single unit the frontal plate 5, radiator 4 feeder's insulation moulder 3, feeder's electronic board 11 and housing 2.

The frontal plate 5 is made of low thermal resistance material, for example—of aluminium or aluminium alloys.

The direct contact of radiator 4 with frontal plate 5 increases significantly the transfer of heat from LEDs 21 to the environment, which allowed to install PIR sensor in the immediate vicinity of LEDs 21.

The top cover 6 has the form of a rectangular moulder with two longitudinal, rectangular ports. These ports have at their bottoms seats for fixing lenses 14, for example—an eliptical lens compound of light sources or in form of rectangular moulder of trapezoidal cross-section, having an internal longitudinal channel with a convex, half-round bottom. The top cover 6 of the housing has also a central port designed for fixing PR sensor's protective dome 15 or Fresnel lens, as well as two ports situated on the opposite sides of this hole. These ports have seats placed from the bottom side of top cover 6, for adjustment knobs 9 fixing. Along shorter sides of the top cover 6 there are four 6a protrusions, making advisably integral part of the top cover 6 and equipped with catches 6b for fastening the top cover 6 in the opening of frontal plate 5. Springy catches 6b may have any structure, but it is advisable to make them as integral part of 6a protrusions of the top cover 6. The protrusions 6a mate with notches 5b situated on the circumference of rectangular hole 5a in the frontal plate 5.

It is obvious that the top cover 6 may not be equipped with 6a protrusions with springy catches 6b and can be fastened to the frontal plate 5 with screws or any other way.

The top cover 6 is made of any electroinsulating plastic, for example—of ABS. The assembling of the lamp consists in mounting the cover 1 set i.e. in connecting the socket 16 and connecting cube 17 with the cover 1. The socket 16 and cube 17 are connected by electric cables.

Simultaneously, the assembling of lighting set can be done. It consists in placing feeder's electronic board 11 in the housing 2: feeder's electronic board 11 supports on housing 2 walls' protrusions 2b, then insulation moulder 3 is placed in the recess in collar 2a and, after that, the radiator 4 is placed in it, by introducing radiator 4 bars 4a into the respective holes in feeder's insulation moulder 3. Using its bars 4a radiator 4 presses feeder's electronic board 11 against protrusions 2b. In case of applying bars 4a with smaller diameter ends, these ends are introduced into the respective holes in feeder's electronic board 11, which prevents displacing feeder's electronic board 11 inside the housing 2.

After fixing the radiator 4, the frontal plate 5 is being set and all details and units are combined into a single assembly, by use of screws 18 screwed into the bars 2c of the housing 2. After connecting frontal plate 5 with housing 2, plates 13 with LEDs 21 and insulation moulder 7 are placed in radiator's 4 seats. Then, PIR sensor electronic board 12 together with fixed protective dome 15 and adjustment knobs 9 are placed in bars 4b. Thanks to the bars 4b of radiator 4, the board 12 is fixed in the insulation moulder 7 keeping a distance from the bottom. In case of applying bars 4b with smaller diameter ends, these ends are introduced into the respective holes in PIR sensor electronic board 12, which prevents displacing PIR sensor electronic board 12 inside the insulation moulder 7.

Then, the lenses 14 are fitted in radiator's 4 seats, in which plates 13 with LEDs 21 have been previously placed, and the whole unit is closed with the top cover 6, by pressing catches 6b of the top cover 6 in notches 5b of the frontal plate 5. The cover 6 presses lenses 14 against plates 13 with LEDs 21 to the bottom of the seat, the plates—in turn—are pressed to the bottom of seats in radiator 4, ensuring better carrying away of heat. It also fasten the adjustment knobs 9, placed in seats in the top cover 6, preventing their falling out or displacement.

Such constructional solution of the lamp, according to the invention, giving—after the final assembling—two autonomous units i.e. feeding socket cover unit 1 and lighting unit, composed of the housing 2 containing feeder and LEDs 21 mounted inside it, allows an emergency, temporary replacement of the lighting unit with a light bulb having an adequate cap—for example, if the feeding socket 16 mounted in the cover 1 represents the GU 10 type, the light bulb with GU 10cup is applied. The construction of the lamp according to the invention facilitate its assembling in situ (in place of use)—the access to the inside of the cover 1 as well as its assembling on the required surface is easy. It is also easy and safe to connect the lamp to a power source—the feeding cables have to be connected to the connecting cube 17 only, other lamp units are disconnected and there is no danger of their accidental launch.

The isolation of feeding socket 16 from other parts, by placing it in separate housing—cover 1, full isolation of feeder's electronic board 11 from environment and feeding socket 16 through its hermetic closure in housing 2 by use of insulation moulder 3, isolation of PIR sensor electronic board 12—confined in insulation moulder 7 closed by the top cover 6, as well as the application of electrically insulated passages for connectors—such as collars in insulation moulders 3 and 7 allowed to achieve a very high voltage insulation, which was never reached in other alternative solutions found in the market.

The lighting unit is connected with the cover 1 by inserting ends 2g of the seat 2f in the holes of the feeding socket 16. The collar 2e is designed to give the feeding socket 16 an additional insulation. It also facilitate the insertion of seat 2f into the feeding socket 16, and then it makes easier turning the whole unit in relation to the cover 1 in order to achieve mechanical connection of its catches 1e with catches 2d of the housing 2. In order to disassembly the unit, the housing 2 should be rotated again in relation to the cover 1. The cover 1 should be connected with the lighting unit before transportation or after fixing the cover 1 in lamp working place.

It is obvious, that constructional solutions presented above are taken by the way of example and do not impose restrictions on the essence of the invention.

1. The LED lighting lamp characterized in that contains the cover (1) in the form of cubicoid open at the top, with “U” letter shaped cross-section, having a port (1a) for power leads, ports for cover (1) fixing, an external collar (1b), catches (1e), feeding socket (16) and feeders' connecting cube (17), fixed inside the cover (1) to its bottom; a housing (2) in the form of cubicoid open at the top, with “U” letter shaped cross-section, having an external collar (2a) with rectangular recess, protrusions (2b) arranged on the vertical walls inside the housing (2), bars (2c), catches (2d), a seat (2f) in which the PIN ends (2g) are fastened to be connected with feeding socket (16), wherein the catches (2d) are connected with cover (1) catches (1e); an electronic board of the feeder (11), with ports for housing (2) bars (2c), electronic elements and electrical connectors placed on the upper surface as well as connector support (10) placed on the lower surface and connected with PIN end's pins (2g) of the housing's (2) seat (2f) insulation molder (3) in the form of a rectangular plate, fastened in the housing (2) collar's (2a) recess and having a central rectangular cavity with “U” letter shaped cross-section and rectangular and round ports in its bottom; a radiator (4) in the form of a rectangular molder, fastened in the cavity of insulation molder (3) and having on its upper surface a central rectangular seat with “U” letter shape cross-section, inside which, at least two bars (4b) and one port are placed on its lower surface; two rectangular seats with “U” letter shaped cross-section, placed in parallel on both sides of the central seat, having a depth lower than the central seat as well as the equal width, each of them having in its bottom a port and at least two bars (4a) situated on the lower surface of the radiator (4), which pass through the holes in insulation molder (3) pressing the electronic board of the feeder (11) against protrusions (2b) in housing (2), and—at least—two ports for screws (18), insulation molder (7) fixed in the central seat of radiator (4) and having in its bottom at least two ports for bars (4b), one rectangular port with a collar (7a) situated on the external surface of insulation molder's (7) bottom, passing outside radiator (4) through the rectangular hole in the bottom of radiator's (4) central cavity; PIR sensor electronic board (12), fastened in the insulation molder (7), keeping a gap from its bottom and supported by the radiator's bars (4b); at least two plates (13) with LEDs (21), fastened in radiator's (4) shallow seats in such a way that the lower surface of the plate (13) keeps direct contact with the bottom surface of radiator's (4) seat; a rectangular frontal plate (5), connected by screws (18) to the bars (2c) and fixing the radiator (4) in insulation molder's (3) cavity, having a central rectangular hole (5a), notches (5b) in the corners, ports for screws (18) and an insulating molder (13) in housing (2) collar's (2b) recess, top cover (6) in the form of rectangular molder, having at least two longitudinal, rectangular ports with seats from underneath, a central large-diameter port, two small-diameter ports situated on opposite sides of the central port and having seats from the top cover's (6) bottom side, at least two protrusions (6a) with springy catches (6b), situated along opposite sides of the top cover (6), fastened in the frontal plate's (5) notches (5b) and connecting the top cover (6) with the frontal plate (5); light source lenses (14), fixed with LED (21) plates (13) in radiator's (4) seats by use of seats in the top cover (6) pressing LED (21) plates (13) against seats' bottoms; optical element (15) of PIR sensor, fitted in the central port, between PIR sensor electronic board (12) and the top cover (6), and adjustment knobs (9), fixed in top cover's (6) seats, between PIR sensor electronic board (12) and the top cover (6).

2. The LED lighting lamp according to the claim 1, characterized in that the cover (1) has a collar (1c) in the form of cylinder, in which a feeding socket (16) as well as a seat (1d) to fix the connecting cube (17) are fastened.

3. The LED lighting lamp according to the claim 1, characterized in that the feeding socket (16) is fixed to the cover's (1) in bottom with screws (19) and nuts (20).

4. The LED lighting lamp according to the claim 1, characterized in that the housing (2) has on its lower surface a collar (2e) in the form of cylinder, concentric with the seat (2f) for an additional feeding socket's (16) insulation.

5. The LED lighting lamp according to the claim 1, characterized in that the bars (4a) have ends with smaller diameters than their other sections, allowing them to enter into the holes in the electronic board of the feeder (11).

6. The LED lighting lamp according to the claim 1, characterized in that the bars (4b) have ends with smaller diameters than their other sections, allowing them to enter into the holes in PIR sensor electronic board (12).

7. The LED lighting lamp according to the claim 1, characterized in that on the upper surface of the PIR sensor electronic board (12) a base (8) and electronic elements of PIR sensor are fixed, while electrical outputs in the form of pins (12a), passing through insulation molder's (7) collar (7a) and introduced to the connector in the electronic board of the feeder (11) are placed on the lower surface of the PIR sensor electronic board (12).

8. The LED lighting lamp according to the claim 1, characterized in that the electronic LEDs (21) plate (13) has electronic elements and at least one LED (21) fixed on its upper surface, while electrical outputs in the form of pins (13a), passing through the hole in radiator's (4)seat and introduced to the connector in the electronic board of the feeder (11) are placed on the lower surface.

9. The LED lighting lamp according to the claim 1, characterized in that a cuboidal molder of trapezoidal cross-section, having an internal longitudinal channel with a convex, half-round bottom makes the light source lens (14).

10. The LED lighting lamp according to the claim 1, characterized in that the light source lens (14) is constituted by an eliptical lens compound.

11. The LED lighting lamp according to the claim 1, characterized in that a dome is the optical element (15) of PIR sensor.

12. The LED lighting lamp according to the claim 1, characterized in that a Fresnel lens is the optical element (15) of PIR sensor.

13. The LED lighting lamp according to the claim 1, characterized in that springy catches (6b) make the integral part of top cover's (6) protrusions (6a).
